(19) United States
(12) Patent Application Publication
(10) Pub. No.: US 2002/0095606 A1
(43) Pub. Date: Jul. 18, 2002

(54) Method and apparatus for delivering software applications as services over the internet using a transaction-based utility model

(75) Inventor: Darryl J. Carlton, (US)

Correspondence Address: David H. Jaffer, Pillsbury Winthrop LLP, 2550 Hanover Street, Palo Alto, CA, 94304-1115, US

(73) Assignee: BizTone. com, Ltd.

(21) Appl. No.: 09/845,732

(22) Filed: Apr. 30, 2001

Related U.S. Application Data
(60) Provisional application No. 60/200,966, filed on May 1, 2000.

(51) Int. Cl. H04L 9/32

(52) U.S. Cl. 713/201

(57) ABSTRACT

A method and system for the sale of software applications services through the Internet. A user accesses the Internet from a client machine that secures connection to a web top server, including a software service web site. The web top server provides the required user interface components. A database server contains user related persistent data and performs software service computation on the data as instructed by an application server, including processing user input data and providing corresponding result data. The applications server processes communication between the web top server and the database server, performs the required software service computations, including processing user input data and providing corresponding result data, and contains the functionality required for recording user transaction and billing operations.

The present application claims priority from United States Provisional Patent Application Serial No. 60/200,966 filed May 1, 2000.

### BACKGROUND OF THE INVENTION

1. Field of the Invention

The present invention relates generally to methods and apparatus for the sale of products over the Internet, and more particularly to a method of providing software applications as services over the Internet using a transaction based utility model.

2. Description of the Prior Art

Traditionally, the Internet has been used for the sale of products in a similar manner to a mail order catalog. Items and prices are reviewed and orders for goods are placed, which are then shipped to the consumer's address. Certain types of information can also be purchased over the Internet, such as a copy of a United States Patent, which can be downloaded and a hard copy printed on a consumer's printer. Other information services include stock market data and news event information, etc. Modern businesses also have a need for software in various areas of technology, such as accounting, business management, and product design. The purchase and maintenance of these programs can be a major expense, especially for smaller businesses where usage is infrequent, but mandatory. In some cases, this situation requires costly subcontracting due to the lack of even more costly computational/analytical facility. The current method of software acquisition through the Internet is generally similar to other products, wherein the desired product is selected and then delivered through physical media such as a CD-ROM, or alternatively through a download over the Internet. In addition to the high cost of purchase of many specialty software programs, additional costs are incurred in maintenance and upgrading the software.

### SUMMARY

It is therefore an object of the present invention to provide a method that gives a consumer access to sophisticated applications software at a lower cost.

It is a further object of the present invention to provide a consumer access to applications software through the Internet at a cost on a usage basis.

It is a still further object of the present invention to provide software applications as transaction-based utility services over the Internet utilizing a multi-tiered software architecture.

It is another object of the present invention to provide software applications over the Internet with a multi-tiered architecture that partitions software functions into “presentation,” “business functions” and “data components.”

It is an object of the present invention to provide software to a user that is upgraded without intervention by the user.

Briefly, the present invention provides a method and system for the sale of software applications services through the Internet. A user accesses the Internet from a client machine that secures connection to a web top server, including a software service web site. The web top server provides the user with the required interface components. A database server contains user related persistent data and performs software service computation on the data as instructed by an applications server, including processing user input data and providing corresponding result data. The applications server processes communication between the web top server and the database server, performs the required software service computations, including processing user input data and providing corresponding result data, and contains the functionality required for recording user transaction and billing operations.

### IN THE DRAWING

FIG. 1 is a flow chart of a preferred method of the present invention; and

FIG. 2 is a block diagram of a system of the present invention.

### DETAILED DESCRIPTION OF THE PREFERRED EMBODIMENT

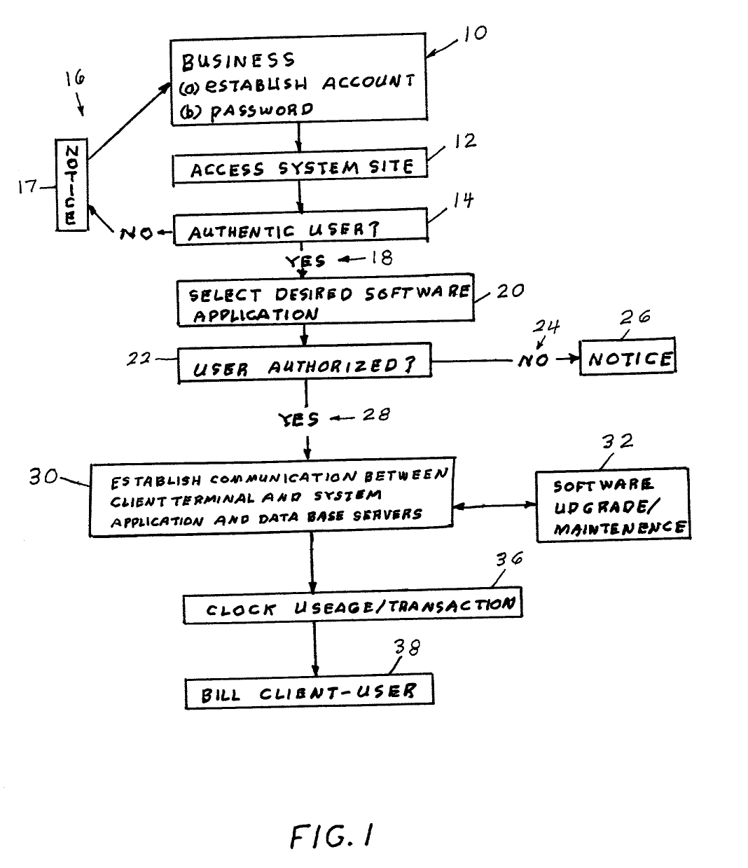

A preferred embodiment of the method and system of the present invention is illustrated in the flow chart of FIG. 1 of the drawing. According to the method, an authorized user can obtain access to a system computer and database containing a desired software program and computational functionality. The system computer facility retains the applications software, performs the requested computations and prepares corresponding result data to be sent to a client terminal through the Internet, all in response to a client/user's request. The client's usage is charged to the client on a pre-arranged basis, which can be by transaction or by time. The billing rate may depend on various factors including the specific program selected, the computational facility required, and the amount of storage used.

The method of charging for software usage according to the present invention departs from the conventional prior art method of purchasing software that is installed on a user's computer and paying for maintenance. The method of the present invention has the advantage of allowing businesses access to a software applications service through the Internet, wherein selected software and computational facility is purchased on a usage basis, at what can often be a lower cost for a project than would be the case if the software had to be purchased and installed on a client/user's machine. Another advantage of the present system is that upgrades are made as required, and are immediately available to the user without any intervention by the user.

According to FIG. 1, a potential user establishes an account (10) with the software applications service company. This can be done through accessing the service company/system web site (12), or alternatively by any of various other methods that will be apparent to those skilled in the art. Upon access to the system site, a method of security is provided, which is indicated as a password, but can take other forms as will be understood by those skilled in the art. As indicated above, either a new or established user can access the system network site (12). The site can optionally supply system advertising, and as indicated above, can also provide the required forms for establishing an account. Generally, an established user will enter some required form of identification/authorization. If the user indicates that he/she does not have an account, or if an entered authentication does not match a corresponding authentication stored in the system, the user is referred to establish an account or enter the required authentication/password (block 10). FIG. 1 indicates the referral with path (16) and notice (17), informing the user of what is required, etc. In this way, an account can be established through access to the system site, as well as by other methods of communication with the software rental system. If the person has an account (18) and successfully logs in, the system will present the user with available selections, and/or allow the user to enter his/her choice of desired software application (20). The system then checks to be sure that the user is authorized to access the selected software, and alternatively to additionally check that the account is currently active and in good standing (22). If it is not (24), a notice is given (26). If access is approved (28), the system connects the user's terminal with a system applications server through a web top server that provides the required user interface 30. The user can then proceed to operate the software program as if it were located on the user's computer. The computations and data storage, however, are all done on the system application server and/or database server in response to user instructions and/or data input. In this way, the user avoids the cost of purchasing/downloading the software to his/her computer, and the cost of maintenance. The operation of the software as described above is also indicated/implied by block 30. The additional benefit of software maintenance and/or upgrades is indicated by block 32. A record is kept by the application server of client/user operation (36), and the client/user is billed for the usage 38.

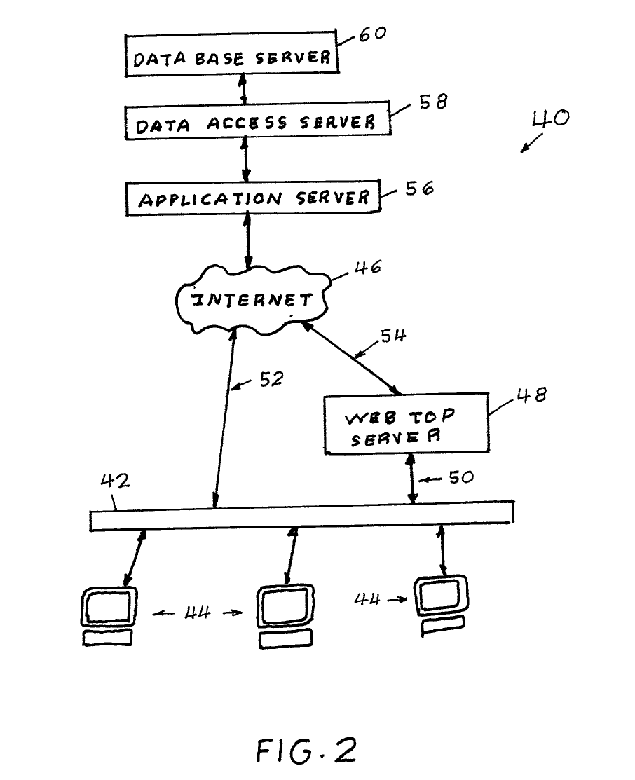

A preferred system hardware arrangement 40 for implementation of the method and system of the present invention is illustrated in FIG. 2. A service provider network 42 is generally included for providing any number of client machines/terminals 44 access to the Internet 46. A preferred embodiment of the present invention includes a web top server 48 that is accessed initially by a client browser on each client machine 44. This access can be facilitated directly 50 through network 42, or by accessing 52 the Internet 46 and then 54 to the server 48. The system 40 includes the web top server 48, an application server 56, a data access server 58 and a database server 60. The web top server 48 provides the required interface to the client machines 44. For example, the web top server can serve HTML pages containing applets, providing the user interfaces for a particular software application requested by the user. The order of operational events up to this point of the description includes the user operating a client machine 44 to access the web top server. The web top server provides the user with selections, and upon activation by the user, the web top server makes a required contact with the application server 56. The application server 56 processes calls from the web top server 48 to the database 60 via the data access server 58. The application server reads and writes from and to the database 60 via the data access server 58. Data is returned to the web top server, for example via a Java Servelet.

The application server manages the reception, retention, and maintenance of client account information/data, including client identification, security measures such as a password, and an accounting/record of a consumer's usage, and billing data and procedures. When a user logs onto the system, the application server may check the specific user's account balance and make a determination to allow or disallow the user's access to a specific software application.

The database server 60 contains the application related persistent data, and runs on all SQL compliant relational databases, e.g., IBM DB2, Sybase, Informix and MS SQL. The application and database servers receive the necessary input data from a user for running a selected program. The servers then respond to the user's direction and proceed to perform the operations of the selected program and provide the results. User input data and program results are communicated from and to the user through the web top server from and to the client terminal. Only the results and input data are handled and potentially stored on the client machine.

Although the present invention has been described above in terms of a specific embodiment, it is anticipated that alterations and modifications thereof will no doubt become apparent to those skilled in the art. For example, specific server functions have been separately defined for servers 48, 56, 58 and 60. The present invention also includes these functions in any of various combinations of servers, such as the functions of servers 56, 58 and 60 all in one physically located server, etc. It is therefor intended that the following claims be interpreted as covering all such alterations and modifications as fall within the true spirit and scope of the invention.

What is claimed is:

1. A method for providing a software application service over the Internet comprising:
(a) accessing a service site on the Internet;
(b) authenticating a user for access to said software application service through a log-in process, through said service site;
(c) authorizing said user for access to a selected software application provided by said service;
(d) sending a service request form to a said user's terminal;
(e) receiving a user's completed said service request form over the Internet, said form including a said user's input data required to perform said selected software service;
(f) performing said software service, including sending service result data over said Internet to said user's terminal;
(g) recording a record of said performing; and
(h) billing said user for said performing.

2. A method as recited in claim 1 wherein said authenticating includes
(a) storing user valid authentication data in a database; and
(b) comparing a user entered log-in authentication data with said valid authentication data for a match.

3. A method as recited in claim 2 wherein said authorization includes
(a) storing user valid authorization data in a database; and
(b) comparing a user entered log-in authorization data with said valid authorization data for a match.

4. A method as recited in claim 2 further comprising sending a notice to said user if said log-in authentication data does not match said valid authentication data.

5. A method as recited in claim 3 further comprising sending a notice to said user if said log-in authorization data does not match said valid authorization data.

6. A system for providing a software application service over the Internet comprising:
(a) a web top server for providing a user interface to a software applications service over the Internet;
(b) a database server for storing software application persistent data and for performing software application computing in response to input data; and
(c) an application server for performing a business function related to said software application service, and for processing communication between said web top server and said database server, and for providing said input data.

7. A system as recited in claim 6 wherein said web top server includes presentation functionality for providing display screen data to a client terminal.

8. A system as recited in claim 6 wherein said business function includes recording software application service provided to a user.

9. A system as recited in claim 8 wherein said business function includes preparing billing data for use in billing a user for software application service provided.

10. A system as recited in claim 6 wherein said software computing includes preparing result data for transmission to a client terminal through said applications server and said web top server.

11. A system as recited in claim 6 wherein said input data includes user supplied input data.

12. A system as recited in claim 6 wherein said software application computing includes preparing result data for transmission to a client terminal, including transmission through said web top server.
